(19) United States
(12) Patent Application Publication
(10) Pub. No.: US 2012/0329963 A1
(43) Pub. Date: Dec. 27, 2012

(54) Catalyst Components for the Polymerization of Olefins

(75) Inventors: Diego Brita, Ferrara (IT); Gianni Collina, Ferrara (IT); Daniele Evangelisti, Ferrara (IT); Benedetta Gaddi, Ferrara (IT); Maria Carbonara, Ferrara (IT); Paolo Vincenzi, Ficarolo (IT)

(73) Assignee: BASELL POLIOLEFINE ITALIA S.R.L., Milano (IT)

(21) Appl. No.: 13/582,230

(22) PCT Filed: Mar. 1, 2011
(86) PCT No.: PCT/EP11/52985

§ 371 Date: Aug. 31, 2012

Related U.S. Application Data
(60) Provisional application No. 61/340,617, filed on Mar. 19, 2010.

(30) Foreign Application Priority Data
Mar. 8, 2010 (EP) 10155773.4

(51) Int. Cl. C08F 4/642; C08F 10/02; C08F 4/649

(52) U.S. Cl. 526/125.8; 502/126; 502/134

(57) ABSTRACT

The present invention relates to catalysts component for the polymerization of ethylene and its mixtures with olefins CH₂═CHR, wherein R is an alkyl, cycloalkyl or aryl radical having 1-12 carbon atoms, comprising Ti, Mg, halogen, and electron donor belonging to 1,2-diethers as internal electron donor compound. The catalyst of the invention is suitably used in (co)polymerization processes of ethylene to prepare (co)polymers having narrow Molecular Weight Distribution (MWD) and high bulk density.

This application is the U.S. national phase of International Application PCT/EP2011/052985, filed Mar. 1, 2011, claiming priority to European Application 10155773.4 filed Mar. 8, 2010 and the benefit under 35 U.S.C. 119(e) of U.S. Provisional Application No. 61/340,617, filed Mar. 19, 2010; the disclosures of International Application PCT/EP2011/052985, European Application 10155773.4 and U.S. Provisional Application No. 61/340,617, each as filed, are incorporated herein by reference.

The present invention relates to catalyst components for the polymerization of ethylene and its mixtures with olefins CH₂═CHR, wherein R is an alkyl, cycloalkyl or aryl radical having 1-12 carbon atoms, comprising Ti, Mg, halogen, characterized by a specific combination of particle size and porosity. The catalyst component of the invention is particularly suitable to be used in slurry (co)polymerization processes of ethylene to prepare (co)polymers in very high yield and bulk density.

Slurry polymerization for preparing ethylene polymers is a known technique in which a non polymerizable hydrocarbon diluent is used as reaction medium. This kind of polymerization is generally carried out in a turbulent flow reactor, such as a continuous pipe reactor in the form of a loop, or in continuous stirred tank reactors. The so-called loop reactor is well known and is described in the Encyclopedia of Chemical Technology, 3rd edition, vol. 16 page 390. This can produce LLDPE and HDPE resins in the same type of equipment.

In this kind of polymerization the capability to polymerize in high yield and high bulk density are key properties for a catalyst. This is particularly important when a multi-step process based on the production of different molecular weight polymer fractions in each single stage is concerned.

In this case in fact, the lower molecular weight fractions are prepared in a polymerization step carried out in the presence of hydrogen which typically has a depressing effect on the activity of the catalyst; under these conditions, if the catalyst does not have a sufficient activity the whole process productivity becomes poor.

On the other hand, high bulk density of the polymer is needed in order to have high plant productivity. According to EP1611175 B1, polymerizing ethylene in slurry loop reactor technology, by using a Ziegler-Natta catalyst having a particle size distribution D50 of less than 20 μm and greater than 5 μm it is possible to produce a lower amount of large polymer particles and an increased polymer bulk density which also results in a higher settling efficiency. The experiments described in EP1611175 B1 do not contain any information whatsoever in terms of the features of the catalyst apart from its size. In fact, the applicant experienced that the solution proposed in said document is not complete in order to obtain a high activity catalyst.

In WO2007/096255 it is disclosed a catalyst in a substantially spherical form comprising Mg, Ti, and halogen as essential elements and containing an electron donor compound of formula (I)

RₐCR₁(OR₄)—CR₂R₃(OR₅) (I)

in which Rₐ is a methyl group or hydrogen or is condensed with R₄ to form a cycle, R₁, R₂ and R₃ are, independently, hydrogen or C1-C20 hydrocarbon groups, possibly containing heteroatoms, R₄ and R₅ are C1-C20 alkyl groups, or R₆CO— groups where R₆ is a C1-C20 alkyl group, or they can be joined with R and R₃ respectively to form a cycle; with the provisions that when Rₐ is hydrogen R₄ and R₅ are not simultaneously methyl and when Rₐ and R₄ form a cycle R₅ is C1-C20 alkyl group. Such a catalyst is said to be useful for slurry PE polymerization. In the example 1, the catalyst has been used with a particle size of 12 μm. The applicant reproduced said catalyst and tested it under appropriate conditions and found that the activity was to be improved.

The applicant surprisingly found that catalyst components combining a certain particle size and porosity show an improved activity and suitability for slurry PE polymerization.

It is therefore an object of the present invention a catalyst component in substantially spherical form comprising Mg, Ti, and halogen as essential elements and having a particle size from 6 to 11 μm and a porosity (P_{F}), measured by the mercury method and due to pores with radius equal to, or lower than, 1 μm, of at least 0.3 cm³/g.

Preferably, the porosity (P_{F}) is higher than 0.4 cm³/g and preferably ranging from 0.4 to 0.9 cm³/g more preferably from 0.4 to 0.7 cm³/g.

Preferably the said solid catalyst component (A) is characterized by a surface area determined by BET method, of lower than 100 and preferably ranging from 30 to 80 m²/g. The porosity measured by the BET method is generally comprised between 0.1 and 0.7 m²/g.

In a preferred aspect the catalyst component of the invention comprises a Ti compound having at least one Ti-halogen bond supported on a magnesium chloride which is preferably magnesium dichloride and more preferably magnesium dichloride in active form. In the context of the present application the term magnesium chloride means magnesium compounds having at least one magnesium chloride bond.

In the catalyst component of the invention the average pore radius value, for porosity due to pores up to 1 μm, is higher than 0.06 μm, preferably higher than 0.08 μm and more preferably in the range 0.085-0.18 μm.

Preferably, the solid catalyst component has an average diameter comprised between 7 and 10 μm. As particles having substantially spherical morphology, those are meant wherein the ratio between the greater axis and the smaller axis is equal to or lower than 1.5 and preferably lower than 1.3. Such values can be measured via known methods such as optical or electronic microscopy.

Particularly preferred are the solid catalyst components in which the Ti atoms derive from a titanium compound which contains at least one Ti-halogen bond and the Mg atoms derive from magnesium chloride. Preferably, in the catalyst of the present invention at least 70% of the titanium atoms and more preferably at least 90% of them, are in the +4 valence state.

In a particular embodiment, the magnesium dichloride is in active form. The active form of magnesium dichloride present in the catalyst components of the invention is recognizable by the fact that in the X-ray spectrum of the catalyst component the major intensity reflection which appears in the spectrum of the non-activated magnesium dichloride (having usually surface area smaller than 3 m²/g) is no longer present, but in its place there is a halo with the position of the maximum intensity shifted with respect to the position of the major intensity reflection, or by the fact that the major intensity reflection presents a half-peak breadth at least 30% greater that the one of the corresponding reflection of the non-activated Mg dichloride. The most active forms are those in which the halo appears in the X-ray spectrum of the solid catalyst component.

In the case of the most active forms of magnesium dichloride, the halo appears in place of the reflection which in the spectrum of the non-activated magnesium chloride is situated at the interplanar distance of 2.56 Å.

Preferred titanium compounds are the halides or the compounds of formula TiXₙ(OR⁷)₄₋ₙ, where 1≦n≦3, X is halogen, preferably chlorine, and R⁷ is C₁-C₁₀ hydrocarbon group. Especially preferred titanium compounds are titanium tetrachloride and the compounds of formula TiCl₃OR⁷ where R⁷ has the meaning given above and in particular selected from methyl, n-butyl or isopropyl.

The catalyst component of the invention may contain also electron donors in order to control the molecular weight distribution. In particular, the presence of internal donors usually narrows the MWD.

The MWD is an important characteristic of ethylene polymers in that it affects both the rheological behavior, and therefore the processability, and the final mechanical properties. In particular, polymers with narrow MWD are suitable for cast films and injection molding in that deformation and shrinkage problems in the manufactured article are minimized. The width of the molecular weight distribution for the ethylene polymers is generally expressed as melt flow ratio F/E, which is the ratio between the melt index measured by a load of 21.6 Kg (melt index F) and that measured with a load of 2.16 Kg (melt index E). The measurements of melt index are carried out according to ASTM D-1238 and at 190° C.

Catalyst components having the capability of giving polymers with narrow molecular weight distribution are also useful to prepare polymer compositions with broad molecular weight distribution. In fact, one of the most common methods for preparing broad MWD polymers is the multi-step process based on the production of different molecular weight polymer fractions in each step, sequentially forming macromolecules with different length on the catalyst particles.

The electron donor compound (ED) can be selected from ethers, esters, amines and ketones. It can be present in amounts such as to give ED/Ti molar ratios in the final solid catalyst component ranging from 0.01 to 5, preferably from 0.05 to lower than 1 and in particular from 0.1 to 0.5.

Preferably the electron donor can be selected from those of formula (I)

RₐCR₁(OR₄)—CR₂R₃(OR₅) (I)

in which Rₐ is a methyl group or hydrogen or is condensed with R₄ to form a cycle, R₁, R₂ and R₃ are, independently, hydrogen or C1-C20 hydrocarbon groups, possibly containing heteroatoms, R₄ and R₅ are C1-C20 alkyl groups, or R₆CO— groups where R₆ is a C1-C20 alkyl group, or they can be joined with R and R₃ respectively to form a cycle; with the provisos that when Rₐ is hydrogen R₄ and R₅ are not simultaneously methyl and when Rₐ and R₄ form a cycle R₅ is C1-C20 alkyl group.

Preferably, in the electron donor compound of formula (I), Rₐ is methyl.

Preferably, in the electron donor compound of formula (I) R₁ to R₃ are hydrogen. When R₄ and R₅ are alkyl groups they are preferably chosen among C1-C5 alkyl groups and more preferably among methyl or ethyl. Preferably they are both methyl. Among R₆CO groups preferred is acetyl.

Specific electron donor compounds of formula (I) are ethylene glycol diacetate, 1,2-dimethoxypropane, 1,2-diethoxypropane, methyl tetrahydrofurfuryl ether. 1,2-dimethoxypropane being the most preferred.

One preferred way to prepare the substantially spherical catalyst components is by reacting the titanium compound having at least a Ti-halogen bond with an adduct of formula a MgCl₂.nROH adduct in the form of substantially spherical particles, having sufficiently small size, where n is generally from 1 to 6, and ROH is an alcohol optionally in the presence of the electron donor of formula (I). The MgCl₂.nROH adduct can be prepared in spherical form from melted adducts, by emulsifying the adducts in a liquid hydrocarbon and thereafter causing them to solidify by fast quenching.

A suitably small average particle size is obtained by providing to the system high energy shear stresses by way of maintaining in the mixer conditions such as to have a Reynolds (R_{EM}) number 10,000 and 80,000, preferably between 30,000 and 80,000. The type of flow of a liquid inside a mixer is described by the above mentioned modified Reynolds number (Re_{M}) which is defined by the formula Re=NL²·d/η in which N is the number of revolutions of the stirrer per unit time, L is the characteristic length of the stirrer while d is the density of the emulsion and η is the dynamic viscosity. Due to what described above, it results that one of the methods to reduce the particle size of the adduct is that of increasing the shear stress provided to the system. This can be done in general by increasing the number of revolutions of the stirrer or, as described in WO05/039745 the description of which is included by reference, by using specific devices for preparing emulsion having the particles of the dispersed phase in suitable small size.

According to WO02/051544, the description of which is herein enclosed by reference, particularly good results are obtained when high Reynolds numbers are maintained also during the transfer of the emulsion at the quenching stage and during the quench as well. When providing sufficient energy to the system, it can be obtained spherical particles of the adduct having the requested small size.

The so obtained adduct particles have average particle size determined with the method described in the characterization section below, ranging from 6 to 11 μm preferably from 6 to 10 μm and preferably with a particle size distribution (SPAN) lower than 1.2, calculated with the formula

$$\frac{P 90 - P 10}{P 50}$$

where, in a particle size distribution curve determined according to the same method, wherein P90 is the value of the diameter such that 90% of the total volume of particles have a diameter lower than that value; P10 is the value of the diameter such that 10% of the total volume of particles have a diameter lower than that value and P50 is the value of the diameter such that 50% of the total volume of particles have a diameter lower than that value.

The particle size distribution can be inherently narrow by following the teaching of WO05/039745 and WO02/051544. However, in alternative to this method or to further narrow the SPAN, largest and/or finest fractions can be eliminated by appropriate means such as mechanical sieving and/or elutriation in a fluid stream.

In particular, the MgCl₂.nROH is caused to react with an excess of liquid TiCl₄ containing electron donor of formula (I) in the optional presence of hydrocarbon solvents. The reaction temperature initially is from 0° to 25° C., and is then increased to 80-135° C. Then, the solid may be reacted once more with TiCl₄, separated and washed with a liquid hydrocarbon until no chlorine ions can be detected in the wash liquid. If used, the electron donor compound of formula (I) is preferably added together with the titanium compound to the reaction system. However, it can also be first contacted with the adduct alone and then the so formed product reacted with the titanium compound. As an alternative method, the electron donor compound can be added after the completion of the reaction between the adduct and the titanium compound.

The reaction can be carried out batchwise through isolation of the solid intermediate product after each step or via a semicontinuous mode in a reaction unity having liquid feeding inlet and filtration means in which the solid starting adduct is added batchwise and the liquid reactants are fed continuously. Such a technique is disclosed for example in WO02/48208 the relevant portion of which is included by reference.

In a preferred aspect of the present invention, before being reacted with the titanium compound, the spherulized adducts are subjected to thermal dealcoholation at a temperature ranging from 50 and 150° C. until the alcohol content is reduced to values lower than 2 and preferably ranging from 0.3 and 1.5 mols per mol of magnesium chloride.

Optionally, said dealcoholated adducts can be finally treated with chemical reagents capable of reacting with the OH groups of the alcohol and of further dealcoholating the adduct until the content is reduced to values which are generally lower than 0.5 mols.

The solid catalyst components according to the present invention are converted into catalysts for the polymerization of olefins by reacting them with organoaluminum compounds according to known methods.

In particular, it is an object of the present invention a catalyst for the polymerization of olefins CH₂═CHR, in which R is hydrogen or a hydrocarbyl radical with 1-12 carbon atoms, comprising the product of the reaction between:

(a) a solid catalyst component as described above,
(b) an alkylaluminum compound and, optionally,
(c) an external electron donor compound.

The alkyl-Al compound can be preferably selected from the trialkyl aluminum compounds such as for example trimethylaluminum (TMA), triethylaluminum (TEAL), triisobutylaluminum (TIBA)), tri-n-butylaluminum, tri-n-hexylaluminum, tri-n-octylaluminum. Also alkylaluminum halides and in particular alkylaluminum chlorides such as diethylaluminum chloride (DEAC), diisobutylalumunum chloride, Al-sesquichloride and dimethylaluminum chloride (DMAC) can be used. It is also possible to use, and in certain cases preferred, mixtures of trialkylaluminum's with alkylaluminum halides. Among them mixtures between TEAL and DEAC are particularly preferred. The use of TEAL and TIBA, alone or in mixture is also preferred. The external electron donor compound can be selected from the group consisting of ethers, esters, amines, ketones, nitriles, silanes and mixtures of the above. In particular, it can advantageously be selected from the C2-C20 aliphatic ethers and in particulars cyclic ethers preferably having 3-5 carbon atoms cyclic ethers such as tetrahydrofurane, dioxane.

The above mentioned components (a)-(c) can be fed separately into the reactor where, under the polymerization conditions can exploit their activity. It may be advantageous the pre-contact of the above components, optionally in the presence of small amounts of olefins, for a period of time ranging from 0.1 to 120 minutes preferably in the range from 1 to 60 minutes. The pre-contact can be carried out in a liquid diluent at a temperature ranging from 0 to 90° C. preferably in the range of 20 to 70° C.

As mentioned, the catalysts of the invention can be used in any kind of slurry polymerization process. They are particularly suited for slurry polymerization in an inert medium, which can be carried out continuously stirred tank reactor or in loop reactors. In a preferred embodiment the solid catalyst components having small average particle size as described are particularly suited for the use in two or more cascade loop or stirred tank reactors producing polymers with different molecular weight and/or different composition in each reactor. The catalysts can polymerize any olefin and preferably alpha olefins like ethylene, propylene, butene-1, hexene-1 etc. However, as already mentioned, the catalysts of the present invention are particularly suitable for preparing in very high yield ethylene polymers with a high bulk density and optionally, with a narrow molecular weight distribution.

In addition, to the ethylene homo and copolymers mentioned above the catalysts of the present invention are also suitable for preparing very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; elastomeric copolymers of ethylene and propylene and elastomeric terpolymers of ethylene and propylene with smaller proportions of a diene having a content by weight of units derived from ethylene of between about 30 and 70%.

The following examples are given in order to further describe the present invention in a non-limiting manner.

### Characterization

The properties are determined according to the following methods:

### Average Particle Size of the Adduct and Catalysts

Determined by a method based on the principle of the optical diffraction of monochromatic laser light with the “Malvern Master Sizer 2000” apparatus. The average size is given as P50.

Porosity and Surface Area with Nitrogen:

are determined according to the B.E.T. method (apparatus used SORPTOMATIC 1900 by Carlo Erba).

Porosity and Surface Area with Mercury:

The measure is carried out using a “Porosimeter 2000 series” by Carlo Erba. The porosity is determined by absorption of mercury under pressure. For this determination use is made of a calibrated dilatometer (diameter 3 mm) CD₃ (Carlo Erba) connected to a reservoir of mercury and to a high-vacuum pump (1·10⁻² mbar). A weighed amount of sample is placed in the dilatometer. The apparatus is then placed under high vacuum (<0.1 mm Hg) and is maintained in these conditions for 20 minutes. The dilatometer is then connected to the mercury reservoir and the mercury is allowed to flow slowly into it until it reaches the level marked on the dilatometer at a height of 10 cm. The valve that connects the dilatometer to the vacuum pump is closed and then the mercury pressure is gradually increased with nitrogen up to 140 kg/cm². Under the effect of the pressure, the mercury enters the pores and the level goes down according to the porosity of the material.

The porosity (cm³/g), both total and that due to pores up to the pore distribution curve, and the average pore size are directly calculated from the integral pore distribution curve which is function of the volume reduction of the mercury and applied pressure values (all these data are provided and elaborated by the porosimeter associated computer which is

### Bulk Density:

DIN-53194

### Determination of Mg, Ti₍ₜₒₜ₎:

has been carried out via inductively coupled plasma emission spectroscopy (ICP) on a “I.C.P SPECTROMETER ARL Accuris”.

The sample was prepared by analytically weighting, in a “fluxy” platinum crucible”, 0.1÷03 g of catalyst and 3 gr of lithium metaborate/tetraborate 1/1 mixture. The crucible is placed on a weak Bunsen flame for the burning step and then after addition of some drops of KI solution inserted in a special apparatus “Claisse Fluxy” for the complete burning. The residue is collected with a 5% v/v HNO₃ solution and then analyzed via ICP at the following wavelength: Magnesium, 279.08 nm; Titanium, 368.52 nm; Alluminum, 394.40 nm.

### Determination of Cl:

has been carried out via potentiometric tritration.

### Determination of OR Groups:

via Gas-Chromatography analysis

Porosity and Surface Area with Nitrogen:

are determined according to the B.E.T. method (apparatus used SORPTOMATIC 1900 by Carlo Erba).

### Melt Index:

Melt index (M.I.) are measured at 190° C. following ASTM D-1238 over a load of:

2.16 Kg,MI E=MI_{2.16}.

21.6 Kg,MI F=MI_{21.6}.

The ratio: F/E=MI F/MI E=MI_{21.6}/MI_{2.16} is then defined as melt flow ratio (MFR)

### General Procedure For The HDPE Polymerization Test

Into a 4.5 liters stainless steel autoclave, degassed under N₂ stream at 70° C., 1.6 liters of anhydrous hexane, the reported amount of catalyst component and 0.5 g of triethylaluminum (TEAL) were introduced. The whole was stirred, heated to 50° C. and thereafter 4 bar of H₂ and 8 bar of ethylene were fed. The reactor temperature was raised to 75° C. and then the polymerization lasted 3 hours during which ethylene was fed to keep the pressure constant. At the end, the reactor was depressurized and the polymer recovered was dried under vacuum at 60° C.

### COMPARATIVE EXAMPLE 1

### Preparation of the Spherical MgCl₂-EtOH Adduct

A magnesium chloride and alcohol adduct containing about 3 mols of alcohol having spherical form and average size of about 12 μm was prepared following the method described in example 2 of EP1673157.

### Preparation of the Solid Component

The spherical support, prepared according to the general method underwent a thermal treatment, under N₂ stream, over a temperature range of 50-150° C. until spherical particles having a residual ethanol content of about 35% (1.1 mole of ethanol for each MgCl₂ mole) were obtained.

Into a 2 l glass reactor provided with stirrer, were introduced 1 L of TiCl₄, 70 g of the support prepared as described above and, at temperature of 0° C., 3,6 ml of 1,2-diemthoxypropane (1,2DMP) (Mg/DMP=16 mol/mol). The whole mixture was heated and kept under stirring for 60 minutes at 100° C. After that, stirring was discontinued and the liquid siphoned off. Two washings with fresh hexane (1 liter) were performed at 60° C. and then, other two more hexane washings were performed at room temperature. The spherical solid component was discharged and dried under vacuum at about 50° C.

The composition of the solid was the following:

| | |
|---|---|
| Total titanium | 4.2% (by weight) |
| Mg | 18.3% (by weight) |
| 1,2-DMP | 2.4% (by weight) |

The so prepared catalyst has then been used in the polymerization of ethylene according to the general polymerization procedure. The results are shown in Table 1.

### EXAMPLE 2

### Preparation of the Spherical MgCl₂-EtOH Adduct

A magnesium chloride and alcohol adduct containing about 3 mols of alcohol having spherical form and average size of about 9 μm was prepared following the method described in example 3 of EP 1673157 using an molten adduct/mineral oil weight feeding ratio of 0.06.

The alcohol reduction content and the catalyst preparation were carried out using the same process and recipe already disclosed in the example 1. The final solid composition is below reported:

| | |
|---|---|
| Total titanium | 6% (by weight) |
| Mg | 17.7% (by weight) |
| 1,2-DMP | 2.7% (by weight) |

Its porosity measured according to the method reported in the description was 0.5 cm³/g. In table 1, polymerization data is reported in comparison with catalyst of example 1.

### EXAMPLE 3

Into a 2 l glass reactor provided with stirrer and a filter was introduced 1.6 L of TiCl₄. The internal temperature was brought to 0° C. and were introduced 320 g of the support prepared as described above and 15.4 ml of 1,2-dimethoxypropane (1,2DMP) (Mg/DMP=20 mol/mol). The whole mixture was heated and kept under stirring for 120 minutes at 100° C. During that time pre-heated TiCl₄ was fed at a rate of 1.6 L/h and the liquid was continuously withdrawn from the reactor to keep constant the initial volume of the suspension. Three washings with fresh hexane (1.6 L) were performed at 60° C. and then, other two more hexane washings were performed at room temperature. The spherical solid component was discharged and dried under vacuum at about 50° C.

The composition of the solid was the following:

| | |
|---|---|
| Total titanium | 5.6% (by weight) |
| Mg | 18.5% (by weight) |
| 1,2-DMP | 2.8% (by weight) |

The polymerization results are reported in table 1.

### COMPARISON EXAMPLE 4

A commercially available catalyst having average size of about 5 micron and porosity lower than 0.3 cm³/g was employed in a polymerization test carried out under same conditions described in the general procedure with the difference that only 7 bar of ethylene were fed and the polymerization time lasted 2 hours. The polymerization results are reported in table 1.

### EXAMPLE 5

The catalyst of Example 2 was employed in a polymerization test carried out under same conditions described comparative example 4. The data are reported in table 1.

TABLE 1

| | Mileage | MIE | | B.D.P. |
|---|---|---|---|---|
| EX. | (KgPE/gctz) | (g/10′) | F/E | g/cc |
| Comp. 1 | 52 | 1.0 | 30.5 | 0.39 |
| 2 | 72 | 1.1 | 28.5 | 0.39 |
| 3 | 86 | 1.5 | 28.2 | 0.40 |
| Comp. 4 | 26 | 0.3 | 34 | 0.288 |
| 5 | 31 | 0.42 | 28.6 | 0.355 |

1. A catalyst component in substantially spherical form comprising Mg, Ti, and halogen having an average particle size from 6 to 11 μm and a porosity (P_{F}), measured by the mercury method and due to pores with radius equal to, or lower than, 1 μm, of at least 0.3 cm³/g.

2. The catalyst component of claim 1 wherein the porosity (P_{F}) is higher than 0.4 cm³/g.

3. The catalyst component of claim 1 wherein the surface area determined by BET method, is lower than 100 m²/g.

4. The catalyst component of claim 1 wherein the average particle size ranges from 7 to 10 μm.

5. The catalyst component of claim 1 further comprising an electron donor compound of formula (I):
RₐCR₁(OR₄)—CR₂R₃(OR₅) (I)
wherein Rₐ is a methyl group or hydrogen or is condensed with R₄ to form a cycle, R₁, R₂ and R₃ are, independently, hydrogen or C1-C20 hydrocarbon groups, optionally containing heteroatoms, R₄ and R₅ are C1-C20 alkyl groups, or R₆CO— groups where R₆ is a C1-C20 alkyl group, or they are joined with R and R₃ respectively to form a cycle; with the provisos that when Rₐ is hydrogen, R₄ and R₅ are not simultaneously methyl, and when Rₐ and R₄ form a cycle, R₅ is C1-C20 alky group.

6. The catalyst component according to claim 5 wherein R₄ and R₅ are alkyl groups chosen from C1-C5 alkyl groups.

7. The catalyst component according to claim 5 wherein R₁ to R₃ are hydrogen.

8. The catalyst component according to claim 5 wherein R₄ and R₅ are methyl.

9. The catalyst component according to claim 5 wherein the electron donor of formula (I) is selected from ethylene glycol diacetate, 1,2-dimethoxypropane, 1,2-diethoxypropane, or methyl tetrahydrofurfuryl ether.

10. The catalyst component according to claim 5 wherein the Ti atoms derive from a titanium compound which contains at least one
Ti-halogen bond and the Mg atoms derive from magnesium chloride.

11. A catalyst for the polymerization of olefins of formula CH₂═CHR, wherein R is hydrogen or a hydrocarbyl radical with 1-12 carbon atoms, said catalyst comprising the product of the reaction between:
(a) a solid catalyst component according to claim 1, and
(b) an alkylaluminum compound.

12. A process for the polymerization of olefins CH₂═CHR, wherein R is hydrogen or a hydrocarbyl radical with 1-12 carbon atoms, said process being carried out in the presence of the catalyst according to claim 11.
